(19) United States
(12) Patent Application Publication
(10) Pub. No.: US 2008/0034568 A1
(43) Pub. Date: Feb. 14, 2008

(54) Vessel Retainer Apparatus

(76) Inventor: Emery Bouchard, Fredericton (CA)

Correspondence Address: JACKSON ESQUIRE;ROGER A. JACKSON, 1115 GRANT STREET, SUITE G-7, DENVER, CO, 80203-2399, US

(21) Appl. No.: 11/623,049

(22) Filed: Jan. 12, 2007

Related U.S. Application Data
(63) Continuation-in-part of application No. 29/259,847, filed on May 17, 2006, now Pat. No. D540031.

(51) Int. Cl. B23P 11/00

(52) U.S. Cl. 29/428

(57) ABSTRACT

A vessel retainer apparatus and method is disclosed for removably engaging a vessel, with the apparatus being adapted to be carried adjacent to a human user. The vessel retainer apparatus includes a resilient sleeve having a circumferential axis, with the resilient sleeve being sized and configured to have a portion of the resilient sleeve partially radially encapsulate a section of a frustroconical portion of the vessel that is adjacent to a vessel neck. Also included is a band element having a longitudinal axis spanning from a first end portion to a second end portion. Wherein, the band element is adjacent to the sleeve at the first end portion and at the said second end portion, with the band element being positioned such that the band longitudinal axis and the sleeve circumferential axis are substantially transverse to one another with the band forming a loop.

### RELATED APPLICATION

This is a continuation in part application of U.S. design patent application Ser. No. 29/259,847 filed on May 17, 2006 by Emery Bouchard.

### TECHNICAL FIELD

The present invention generally relates to an apparatus for retaining a vessel and specifically for retaining a vessel adjacent to a human. More particularly, the present invention relates to the field of lightweight portable apparatus that are capable of removably engaging the vessel in addition to the apparatus also being removably engagable to the human, wherein the vessel retainer apparatus is typically worn by the human during sports and exercise related activities.

### BACKGROUND OF INVENTION

The health benefits of exercise are well known and applicable to all ages of individuals, including cardiovascular improvement, muscle strengthening, stretching, increased blood circulation, better coordination, sharper motor abilities, flexible joint mobility, bone health, general overall wellness, and the like. One problem as an individual typically moves from being a child to being an adult, their physical activity levels decline just when maintaining good health is at its most important as an individual ages, typically their exercise levels decline that can work against maintaining good health, thus just when an individual should be exercising and being active, their exercise and activity levels tend to decrease. Children are normally active in going places (i.e. walking or riding a bike), playing active games in their spare time, such as football, soccer, baseball, tag, hide and seek, and the like, plus being in school children are also active in physical education classes and after school hours sports leagues. Thus, as children we are normally plenty active and in the best of health due to our young age. However, as we become adults, societal norms tend to drive us into a much more sedentary lifestyle, for instance by having a car, we tend to walk very little, nor ride a bicycle much, and as an office worker we tend to sit at a desk for long periods of time, sit in meetings, sit on airplanes, and then go out for high fat and calorie content meals at high end restaurants, thus as a result most adults tend to gain weight by consuming more calories coupled with a lower activity lifestyle, just when our bodies should be in better shape to compensate for aging we typically get in worse shape.

Although the benefits of exercise especially for adults are acknowledged by most everyone for weight control, maintaining agility, preventing diabetes, preventing joint stain from excessive body weight, preventing higher various internal organ workloads (especially the heart) from excessive body weight, and so on, few adults are active enough to maintain even a recommended weight, typically being only about one-fourth of the adult population is not overweight. So the question to ask is, why don't the majority of adults exercise especially if the health benefits are widely known? One probable answer is that available time and convenience are a problem for engaging in an exercise program, as most adults have a full time job, a family, and other interests that all together consume most of an adults time. Thus, a potentially helpful solution is to minimize the time and convenience obstacles to allow for an exercise program to be possible for a working adult.

Thus, one important aspect of especially exercise is that there is growing awareness of the need for people to remain hydrated during exercise, work, or basically any other activity, even when an individual is relatively idle activity wise when they are in a high temperature environment, the need to remain hydrated is critically important. Also, in emergency situations, military exercises, search and rescue operations of which displace a number of people from their typical surroundings bring forth the immediate need to hydrate these individuals quickly and efficiently. This can be in temporary situations where in a particular geographic area has a shortage of potable water for the local inhabitants due to the occurrence of a natural or manmade disasters such as a hurricane, tornado, flooding, loss of electrical power supply (for driving water pumps), local potable water supply contamination, destruction of the water treatment and/or distribution infrastructure, and the like can all lead to the critical shortage of potable water for a particular geographic area's local inhabitants. Alternatively, even without a disaster type situation, potable water can be in short supply such as in geographic areas where rainfall is scarce, or where the area is relatively isolated from ample natural sources of water such as lakes and rivers and/or where there is a lack of a developed water treating and distribution infrastructure that is capable of supplying a minimally sufficient potable water volume to the inhabitants of the water challenged geographic area. Other situations could include areas with low precipitation, or an unacceptably high salinity of surface and/or ground water that is unusable for human consumption. There could be other situations such that he geographic area has rugged terrain that could also make the surface or air transportation of large potable water containers difficult if not impossible, while the same time increasing the possibility of water contamination due to the long periods of water storage, also due to the high weight and large size of water containers that hold sufficient volumes of potable water further adds the impractability of transporting large volumes of water by surface or air. This points to the practical solution of utilizing bottled water to hydrate human's in the unfortunate previously mentioned situations, which again leads to the need for a bottle holder or retainer that is attached to a human's body as most people have a need to be portable or freely movable about a particular geographic area and desire their water supply be readily available.

Further, in yet another scenario to enhance the portability of being an active human especially when exercise is being performed there is the need for a fluid supply that is adjacent to human's body, that in addition has very easy access for the human to grasp the fluid container from its holder, to hydrate themselves, and then to replace the fluid container in the same holder that they removed from with minimal physical, mental, or visual effort. This results in a highly desirable design characteristic of the fluid container holder to be able to be used with only one arm and without the human having to consciously visually observe the holder both to remove the fluid container and subsequently when they replace the fluid container back into the holder. In other words removing and replacing the fluid container from the holder should be a simple operation, almost being performed subconsciously with absolutely minimal distraction from the human being especially important in sports type activities while they're obtaining hydration. Hence the popularity of a backpack fluid container hydration system with a fluid communication tube from the container to being adjacent to the human's mouth, wherein “hands free” hydration can occur, such as the CAMELBACK apparatus, however, the CAMELBACK apparatus has its own drawbacks such as higher cost, less availability, and the hassle of fluid bladder maintenance to keep the fluid storage safe and sanitary as related to a conventional water bottle.

Outside of the backpack fluid container type apparatus, various sizes of fluid containing bottles remain very popular as they are more available, have lower costs, and can be used in a situation where a holder is not needed, for example exercising in a gym, on treadmills, exercise machines, and the like which typically have build in bottle holders. Thus, due to the popularity of bottles a number of bottle holders have been developed that are typically constructed of fabric, net type material, or a resilient type of sheet material that enclose or partially enclose the bottle, or even have a clip that engages a portion of the bottle, such as the bottle neck. The majority of these aforementioned bottle holders have the requirement that they be pretty much custom sized for a particular bottle's height and diameter resulting in not being able to accommodate variance on bottle size, which is a drawback. To facilitate attachment of the bottle holder to the human most holders have either a strap, for shoulder or waist attachment, or a clip for attachment to a belt or pants belt loop allowing the bottle holder to be worn adjacent to the human's waist.

Some prior art examples of bottle retainers or holders would include U.S. Pat. No. 6,394,329B1 to Magee that discloses a relatively rigid clip type bottle retainer that snaps on to the bottle neck thus fulfilling the desire for retaining the bottle during sports activities, i.e. while the user is active, however, the retainer belt attachment to the user is not necessarily positively retained to the user in either just resting against the top of the belt from gravity, see FIGS. 6, 7, and 8, or having a lower retainer channel, see FIGS. 11 and 12, thus allowing the retainer to dislodge from a loose belt and the user subsequently losing the bottle and retainer during high movement activities. Another drawback is the inflexibility in the Magee retainer in accommodating different size bottles, such that Magee relies upon a very consistent bottle neck size to properly removably “clamp” the bottle neck securely while having the “clamp” loose enough to remove and engage the bottle from and to the retainer without too much effort. Continuing, in Canadian design patent number 104734 to Kent-Fawkes a design somewhat similar to Magee in that a fairly rigid structure snaps about a bottle neck or body to retain the bottle in the retainer, however, having the same issues as Magee in limited adaptability to different size bottles to properly secure the bottle in the retainer. In the baby bottle retainer area looking at U.S. Pat. No. 2,953,337 to Valis disclosed is a bottle holder with elastic bands that circumvent the bottle outside diameter including a frustroconical portion of the bottle near the bottle nipple by the use of snaps at the ends of elastic bands, thus securing the bottle in an inverted position which is desirable, however, the snap elastic system is cumbersome and inefficient for sports activity use, requiring too much “fiddling around” for the active human or user wearing the Valis bottle retainer to remove and replace the bottle. Similarly, in U.S. design Pat. No. 293,628 to Teachey which is for a flashlight holder that utilizes a hook and loop fastener flap to retain the flashlight, also requires too much conscious effort to remove and replace the flashlight on the “run” so to speak by opening and closing the flap and aligning the hook and loop fastener, requiring two hands and visual attention from the user.

Further, in U.S. Pat. No. 5,147,079 to Heather disclosed is a bottle retainer that uses a tensioned strap with an eye ring that is disposed over the bottle neck, thus again as in Valis and Teachey there is a positive retention of the bottle in the retainer, however, there is a burdensome strap and eye ring to remove and replace every time the bottle is removed and replaced in the retainer, also again requiring two hands (one for loosening the strap, one for removing the eye ring) and visual attention to complete the task of taking the eye ring off of the bottle and top then later replacing the eye ring onto the bottle neck. In yet another version, in U.S. design Pat. No. 373,677 to Kelly disclosed is a bottle retainer that is very similar to a duffle bag in shape and function, wherein the retainer is cylinder shaped with a drawstring at one end with a compression clamp on the drawstring to pull one end closed around the open end or in other words the bottle neck. Thus, in Kelly the bottle is retained by the drawstring, again however, the drawstring must be manually tightened and manually loosened to remove and replace the bottle from the retainer so still requiring two hands and visual attention, in addition looking at Kelly, the bottle size range that can be accommodated is very limited without making Kelly oversized to accommodate a range of smaller bottles, resulting in the bottles bouncing around inside of the retainer, being somewhat annoying during sports activities to the user. Somewhat like Heather in U.S. Pat. No. 5,941,434 to Green disclosed is a multi strap holder that does positively retain an article, however, requiring two hands and visual attention to remove and replace the article, thus not really being convenient to sports use. Further, in U.S. Pat. No. 6,401,993B1 to Andrino being a highly similar design to Heather with the eye ring securing the bottle neck from up and down or vertical dislodging of the bottle from the retainer, again of course requiring two handed use and visual attention from the user for bottle removal and replacement from the retainer.

Continuing, for bottle retainers that do not restrain the bottle from up and down (vertical) motion, looking in U.S. Pat. No. 5,184,762 to Nevitt disclosed is a harness adapted for a pet to carry bottles utilizing radical straps and an axial strap that are not resilient but flexible, in looking at FIGS. 2 and 3 the bottle is held in place simply by gravity, which makes for easy removal and replacement of the bottle form the retainer, however, not securing the bottle in the retainer, i.e. especially if the pet were to run at a fast pace with an up and down bouncing motion, there is a good possibility that the bottle would dislodge form the retainer. Further, in bottle retainers that also don't restrain the bottle from up and down motion (vertical) see U.S. Pat. No. 5,622,346 to Story, Jr. being similar to Nevitt in using radial straps in conjunction with a vertical strap, see FIGS. 1 and 2, thus again even though the removal and replacement of the bottle from the retainer is easy (one hand and no or little visual attention required) the bottle is not secured in the retainer from vertical movement, making it fairly unacceptable for sports or active use by a human. Also, in this same area, see U.S. Pat. No. 5,806,730 to Deno that discloses a retainer for multiple articles, however, having the same concept as Nevitt and Story, Jr. with simply radially placed straps held together with a vertical strap, there could be a limited degree of vertical or up and down movement restraint due to a radially tight clamping of the hook and loop fastener type radial straps, however, the vertical retention would be slight and there would be no easy removal or replacement of the article from the retainer. See also in U.S. design Pat. No. 419,392 to Schlebusch with a design similar to Story, Jr. in the use of radial straps connected by hook and loop fasteners including vertical straps to provide a bottom support and spacing for the radial straps, with Schlebusch not being really adaptable to sports use by a human.

Continuing, in Canadian design patent number 25964 to Adolph disclosed is a carton holder much like Nevitt in not retaining the carton vertically, with the goal being easy removal and replacement of the carton from and to the holder. Following, in Canadian design patent number 63087 to Fernandes disclosed is another carton type holder, much like Adolph, except for the handle portion, again with the same goals of easy removal and replacement of the carton form the retainer and no vertical movement restraint for the carton to dislodge from the retainer. Also, see Canadian design patent number 80382 to Azar that discloses a retainer with no vertical restraint of the bottle, however, having easy removal and replacement of the bottle from and to the retainer, like Adolph and Fernandes. Yet further, similar in form to Deno, see U.S. patent application publication number 2005/0092788A1 to Jenkins that discloses a baby bottle retainer with radially positioned elastic straps on the cylindrical portion of the bottle and vertical straps for securing the bottom of the bottle and axially spacing apart the radial straps, however, it is not a functional goal of Jenkins to either secure the bottle to the retainer during sports use or have the bottle easily removed or replaced from the retainer. In a like manner as Jenkins, see U.S. patent application publication number 2005/0173478A1 to Gill et al., that discloses a bottle retainer that does not restrain bottle vertical movement, thus Gill et al., being of the same structural design as Jenkins with a radial strap and vertical straps to secure the bottom of the bottle and to axially space apart the radial straps, however, in the Gill et al. patent application publication the bottle could be used (drank from by the user) while the bottle is still in the retainer, necessitating that the bottle retainer be loosely attached to the human user, i.e. through the use of a shoulder strap, which is not preferable for wearing during sports activities, as the bottle and retainer would undesirably swing around and bang against the user's body.

In summary, there are a number of drawbacks to current bottle retainers, one of which is the basic inability to accommodate differing size bottles in a single bottle retainer, another problem is in the situation of where the human user is involved with a sports activity and is highly active they want the water bottle securely adjacent to their body for hydration purposes, wherein the bottle is secured in the retainer, thus the bottle not being easily dislodged from the retainer when the retainer is subjected to omnidirectional movement from the human user being involved in a sports activity. Of course this desired design feature creates its own drawbacks, as if the bottle is positively secured in the retainer, with a snapped flap for instance, this of necessity makes the other desired feature of easy and quick removal and replacement of the bottle from and to the retainer much more cumbersome. What is needed is a bottle holder that has the ability to substantially secure the bottle in the retainer, while the retainer is experiencing omnidirectional movement of the human during sports or other activities while at the same time being easy and simple to remove and replace the bottle from the retainer, while requiring minimal attention from the human user, i.e. preferably requiring only one hand action without the need for visual attention on the part of the human user.

### SUMMARY OF INVENTION

Broadly, the present invention is for a vessel retainer apparatus for removably engaging a vessel, with the apparatus being adapted to be carried adjacent to a human user. The vessel retainer apparatus includes a resilient sleeve having a circumferential axis, with the resilient sleeve being sized and configured to have a portion of the resilient sleeve partially radially encapsulate a section of a frustroconical portion of the vessel that is adjacent to a vessel neck portion. Also included in the vessel retainer apparatus is a band element having a longitudinal axis spanning from a first end portion to a second end portion. Wherein, the band element is adjacent to the sleeve at the first end portion and at the said second end portion, with the band element being positioned such that the band longitudinal axis and the sleeve circumferential axis are substantially transverse to one another with the band forming a loop between the first end portion and the second end portion. Operationally, the vessel is removalby engaged to the vessel retainer apparatus by the vessel being partially disposed within the loop and the resilient sleeve partially radially encapsulating the frustroconical portion of the vessel.

These and other object of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the vessel retainer apparatus assembly,

FIG. 2 shows a side view of the vessel retainer apparatus assembly,

FIG. 3 shows a cutaway view of an alternative embodiment of the vessel retainer apparatus assembly exposing a radial stiffening member that is disposed within a resilient sleeve;

FIG. 4 shows a side view of the vessel retainer apparatus assembly in use with the vessel inserted into and removably engaged by the retainer apparatus assembly.

FIG. 5 shows a side view of the vessel retainer apparatus assembly with an optional collar, the vessel retainer apparatus being in use with the vessel inserted into and removably engaged by the vessel retainer apparatus assembly;

FIG. 6 shows a perspective view of the vessel retainer apparatus in use with the vessel inserted into and removably engaged by the vessel retainer apparatus assembly when the vessel retainer apparatus assembly is adjacent to a human user via a human waistline connector to the human user involved in an active sports activity.

FIG. 7 shows a perspective view of the vessel retainer apparatus assembly in use with the vessel being partially manually engaged/disengaged by removable engagement movement from the vessel retainer apparatus assembly by one hand of the human user when the vessel retainer apparatus is adjacent to the human user via the human waistline connector to the human user involved in an active sports activity, and

FIG. 8 shows a perspective view of the vessel retainer apparatus assembly in use with the vessel inserted into and removably engaged by the vessel retainer apparatus assembly when the vessel retainer apparatus is adjacent to the human user via a human shoulder strap connector to the human user involved in an active sports activity.

### REFERENCE NUMBERS IN DRAWINGS

30 Vessel Retainer apparatus.
31 Alternative embodiments of the Vessel Retainer Apparatus.
32 Resilient sleeve.
34 Resilient sleeve 32 opening.
36 Resilient sleeve 32 circumferential axis.
38 Resilient sleeve 32 axial axis.
40 Resilient sleeve 32 partial radial encapsulation of the vessel frustroconical portion.
42 Radial stiffening member.
44 Resilient sleeve that has a stiffening member 44.
46 Collar.
47 Resilient sleeve 44 that has a stiffening member circumferential axis.
48 Band element.
49 Resilient sleeve 44 that has a stiffening member 42 axial axis.
50 Band element 48 longitudinal axis.
51 Resilient sleeve 44 that has a stiffening member 42 partial encapsulation of the vessel 66 frustroconical portion 72.
52 Band element 48 first end portion.
54 Band element 48 second end portion.
56 Band element 48 being adjacent to the resilient sleeve 32.
57 Band element 48 being adjacent to the resilient sleeve 44 that has a stiffening member 42.
58 Longitudinal axis 50 and circumferential axis 36 being substantially transverse.
59 Longitudinal axis 50 and circumferential axis 36 being substantially transverse for the resilient sleeve 44 that has a stiffening member 42.
60 Band loop.
62 Human 92 waistline connector.
64 Human 92 shoulder strap connector.
66 Vessel
68 Vessel 66 body portion.
70 Vessel 66 base portion.
72 Vessel 66 frustroconical portion.
74 Section of the vessel 66 frustroconical portion
76 Vessel 66 neck portion.
78 Vessel 66 removable engagement movement relative to the vessel retainer apparatus 30 or 31.
80 Vessel 66 resistive/extractive pulling movement relative to the vessel retainer apparatus 30 or 31 to help prevent the vessel 66 from inadvertently disengaging from the vessel retainer apparatus 30 or 31.
82 Vessel 66 retaining force from the resilient sleeve 32 or 44 radially encapsulating the section 74 of the frustroconical portion 72 or the vessel 66.
84 Vessel 66 insertion movement relative to the vessel retainer apparatus 30 or 31 to dispose the vessel 66 within the vessel retainer apparatus 30 or 31.
86 Vessel 66 removably engaged by the retainer apparatus assembly 30 or 31 or more specifically by the resilient sleeve 32 or 44.
88 Vessel 66 being partially disposed within the loop 60 of the band element 48.
90 Vessel 66 base portion entry the rethrough the resilient sleeve 32 or 44 along the axial axis 38.
92 Human user involved in an active sports activity.
94 Single hand of human user 92.
96 Eye contact of the human user 92.
98 Adjacent portion of human user 92 for carrying the vessel retainer apparatus 30 or 31.
100 Vessel retainer apparatus portion adapted to be carried by the human 92 user.
102 Partial manual engagement/disengagement of the vessel 66 from the vessel retainer apparatus assembly 30 or 31.

### DETAILED DESCRIPTION

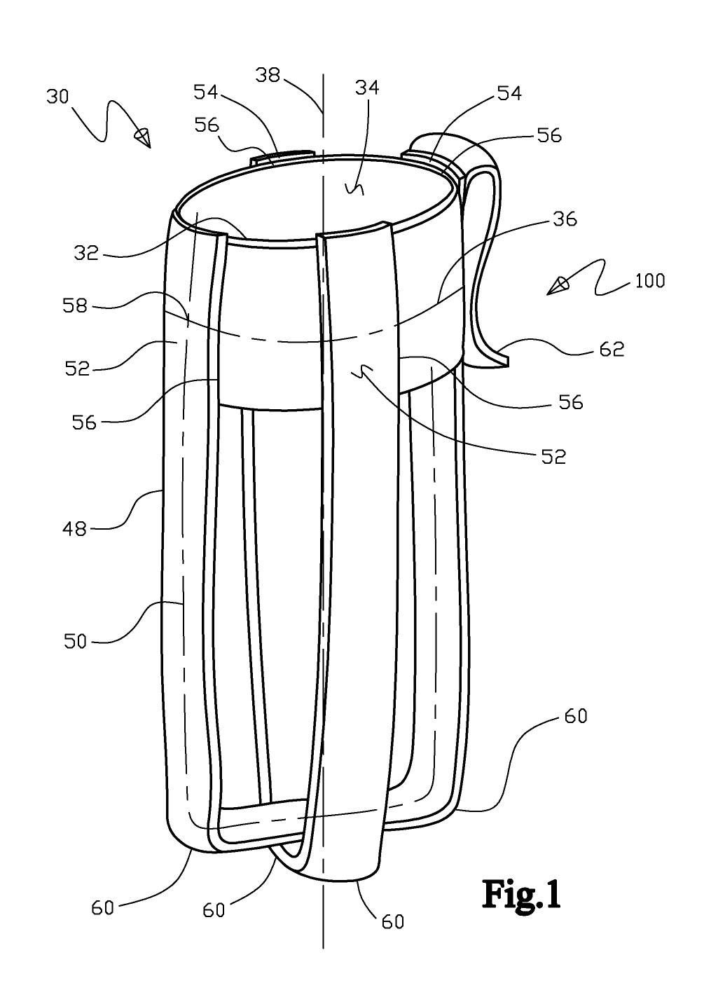

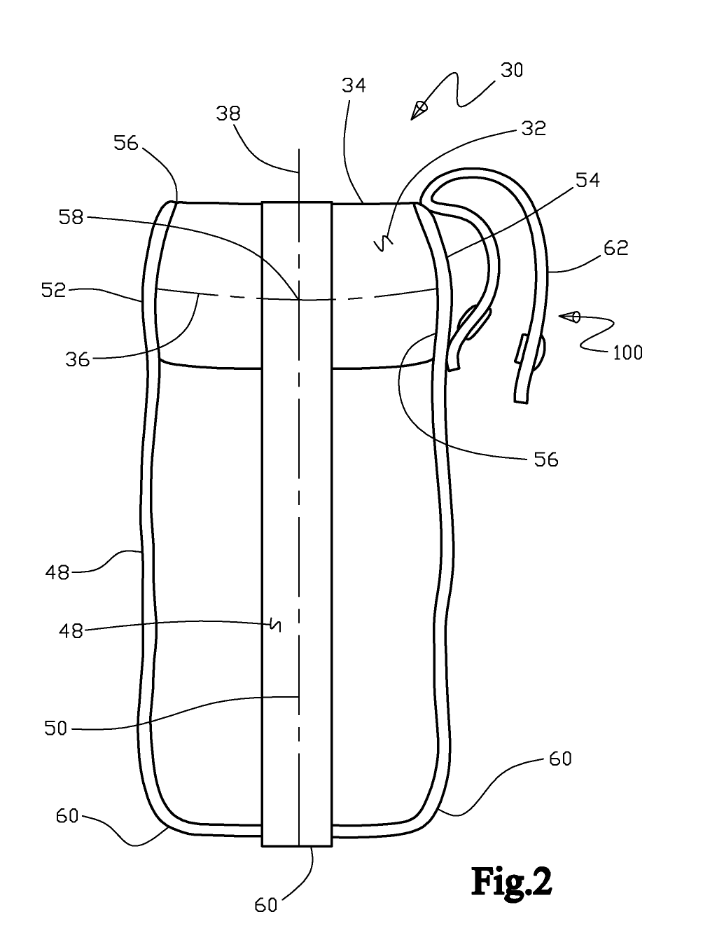

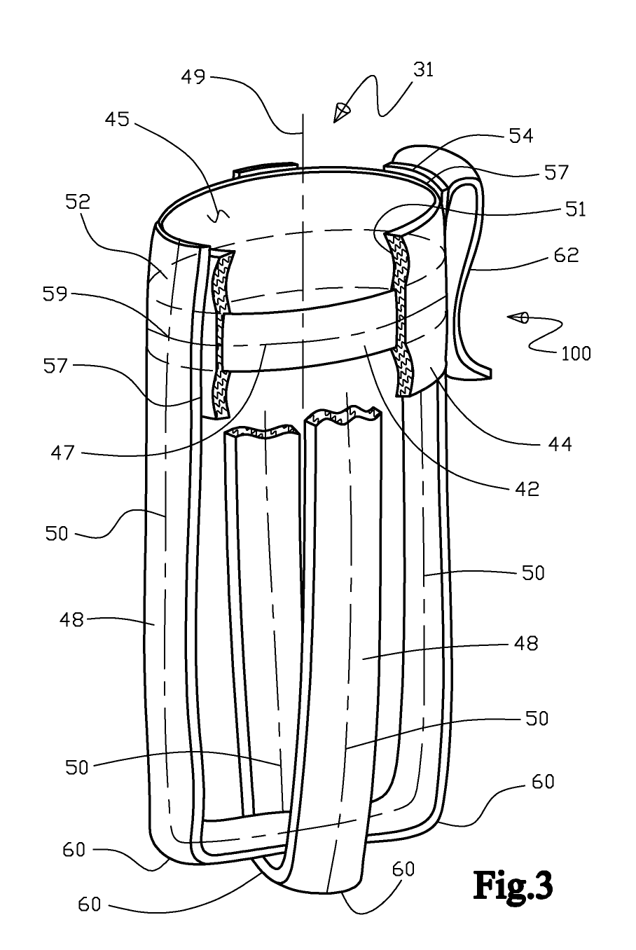

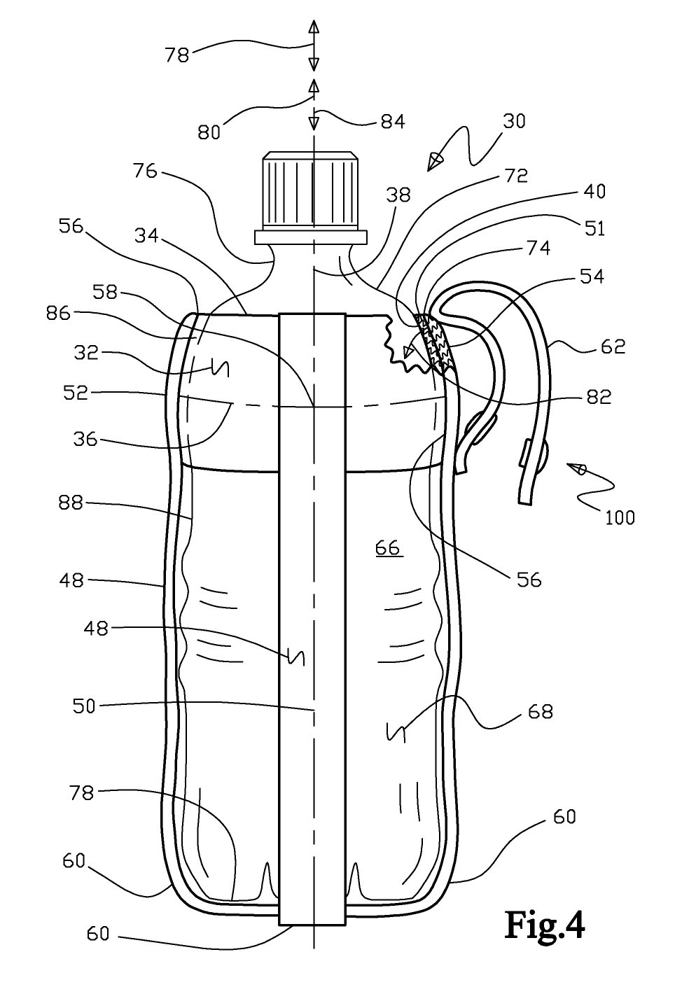

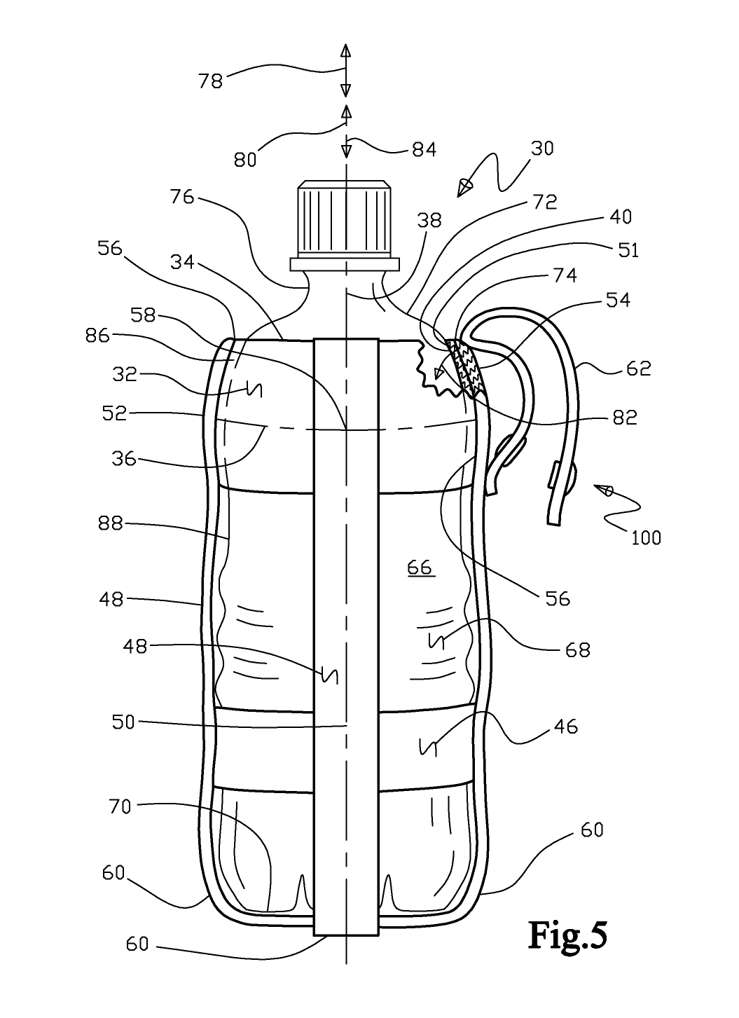

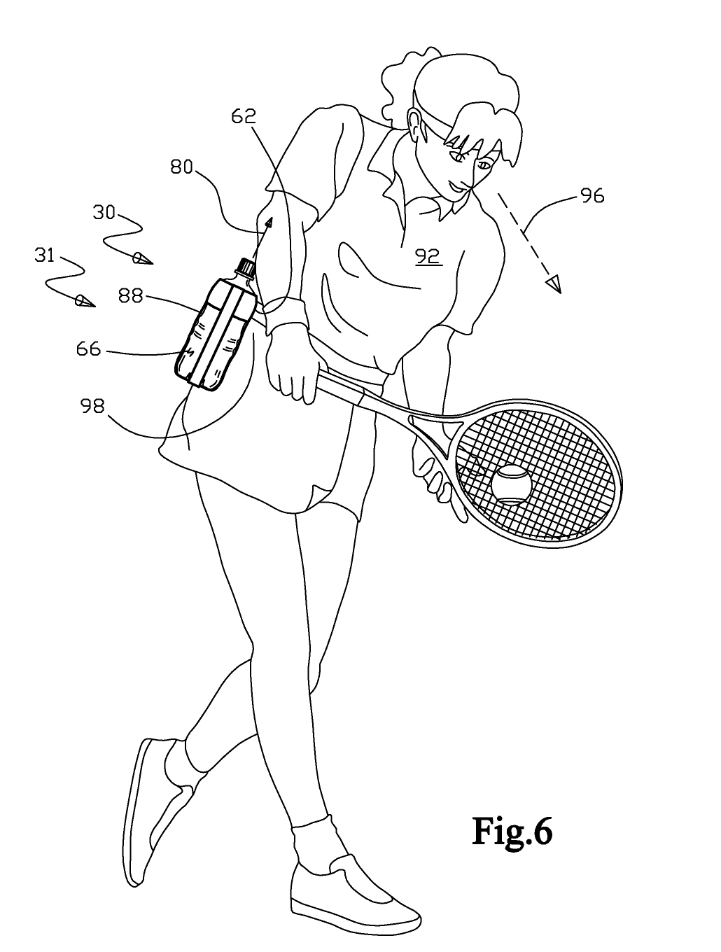

Broadly, with initial reference to FIG. 1 shown is a perspective view of the vessel retainer apparatus 30 assembly, FIG. 2 shows a side view of the vessel retainer apparatus 30 assembly, and FIG. 3 shows a cutaway view of the alternative embodiment of vessel retainer apparatus 31 assembly exposing a radial stiffening member 42 that is disposed within a resilient sleeve 44. Continuing, FIG. 4 shows a side view of the vessel retainer apparatus 30 assembly in use with the vessel 66 inserted into and removably engaged by the retainer apparatus 30 assembly. Further, FIG. 5 shows a side view of the vessel retainer apparatus 30 assembly with an optional collar 46, with the vessel retainer apparatus 30 being in use with the vessel 66 inserted into and removably engaged by the vessel retainer apparatus 30 assembly. Yet further, FIG. 6 shows a perspective view of the vessel retainer apparatus 30 or 31 in use with the vessel 66 inserted into and removably engaged by the vessel retainer apparatus 30 or 31 assembly when the vessel retainer apparatus 30 or 31 is adjacent 98 to a human user 92 via a waistline connector 62 to the human user 92 involved in an active sports activity.

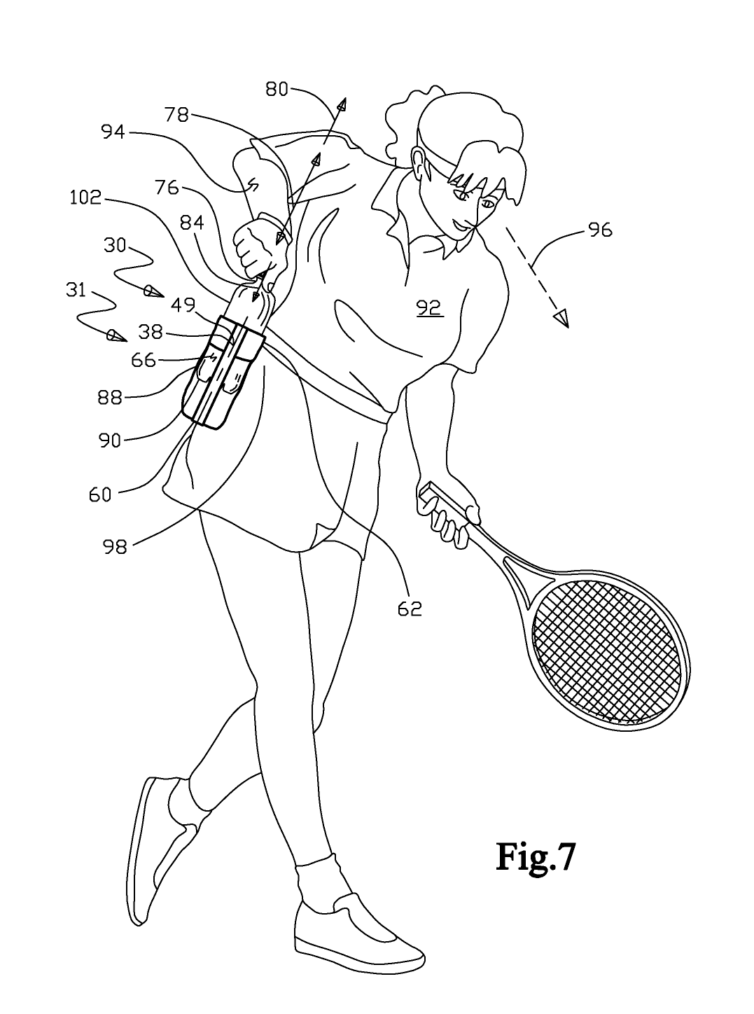

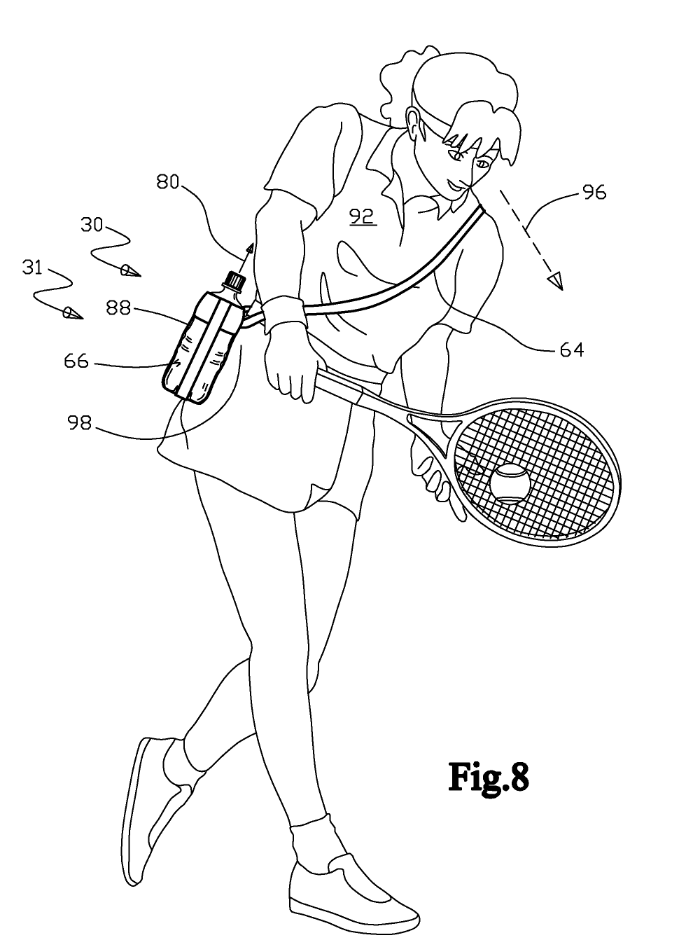

Furthermore, FIG. 7 shows a perspective view of the vessel retainer apparatus 30 or 31 in use with the vessel 66 being partially manually engaged/disengaged 102 in removable engagement movement 78 from the vessel retainer apparatus 30 or 31 assembly by one hand 94 of the human user 92 when the vessel retainer apparatus 30 or 31 assembly is adjacent to the human user 92 via the human waistline connector 62 to the human user 92 involved in an active sports activity. In FIG. 7, making a particular note that only one hand 94 of the human user 92 is required without the need for eye contact 96 of the human 92 to be focused upon the action of the vessel removable engagement movement 78, thus enabling the human user 92 to focus upon their sports activity while at the same time removing/replacing the vessel 66 from the vessel retainer apparatus 30 assembly through movement 78. Next, FIG. 8 shows a perspective view of the vessel retainer apparatus 30 or 31 in use with the vessel 66 inserted into and removably engaged by the vessel retainer apparatus 30 or 31 assembly when the vessel retainer apparatus 30 or 31 assembly is adjacent to the human user 92 via a human shoulder strap connector 64 to the human user 92 involved in an active sports activity.

Broadly, in referring specifically to FIGS. 1 and 2 for physical structure and FIGS. 4 through 8 for method of use, the vessel retainer apparatus 30 for removably engaging a vessel 66 is shown, with the vessel retainer apparatus 30 being adapted 100 to be carried adjacent 98 to a human user 92. The vessel retainer apparatus 30 assembly includes a resilient 32 with an opening 34, also having a circumferential axis 36, with the resilient sleeve 32 being sized and configured to have a portion of the resilient sleeve 32 partially radially encapsulate 40 a section 74 of a frustroconical portion 72 of the vessel 66 that is adjacent to a vessel neck portion 76 as best shown in FIG. 4. Further included in the vessel retainer apparatus 30 is a band element 48 having a longitudinal axis 50 spanning from a band element first end portion 52 to a band element second end portion 54, wherein the band element 48 is adjacent 56 to the sleeve 32 at the first end portion 52 and the second end portion 54. The band element 48 is positioned such that the longitudinal axis 50 and the circumferential axis 36 are substantially transverse 58 to one another with the band 48 substantially forming a loop 60 between the first and portion 52 and the second end portion 54.

Wherein operationally the vessel 66 is removably engaged 78 to the vessel retainer apparatus 30 by the vessel 66 being partially disposed 88 with the loop 60 and the resilient sleeve 32 partially radially encapsulating 40 the frustroconical portion 72 of the vessel 66, in addition to the band element 48 loop 60 receiving the vessel 66 body portion 68 and the vessel 66 base portion 70 as best shown in FIGS. 4 and 5. The preferred materials of construction for the resilient sleeve 32 is a twenty five (25) millimeter wide elastic strap from Cansew, Inc. part number CSK 3500, a close cell foam rubber, or any other alternative material that is lightweight, waterproof, and having adequate strength at the resilient sleeve 32 partial radial encapsulation 40 of the vessel 66 frustroconical portion 72 to create adequate retaining force 82 from the resilient sleeve 32 to the frustroconical portion 72 to enable vessel 66 removable engagement 78 relative to the vessel retainer apparatus 30 as shown in FIGS. 4 and 5.

As an option the vessel retainer apparatus 30 can further comprise a plurality of band elements 48 that are positioned in a substantially juxtapose manner to one another as best shown in FIGS. 1 and 2. Further, as another option the vessel retainer apparatus 30 can further comprise a collar 46 that is adjacent to the plurality band element loops 60 with the collar 46 being positioned substantially juxtapose to the resilient sleeve 32 as shown in FIG. 5. In addition, a yet further option for the vessel retainer apparatus 30 can further comprise the collar 46 that is adjacent to a single band element loop 60 and positioned substantially juxtapose to the resilient 32, although not shown in FIG. 5 specifically with the collar 46 in conjunction with a single band element loop 60, thus would not affect the positioning of the collar 46 as shown in FIG. 5 only having a single band element loop 60. Also, there could be a plurality of collars 46 that could be adjacent to a single band element loop 60, wherein the collars 46 are all substantially juxtapose to the resilient sleeve 32, further there could be a plurality of collars 46 that could be adjacent to a plurality of band element loops 60, wherein the collars are all substantially juxtapose to the resilient sleeve 32 and the band element loops 60 are all substantially juxtapose to one another.

Operationally, the collar 46 further helps the band element 48 loops 60 remain substantially juxtapose to one another, either with a single band element 48 loop 60 or a plurality of band element 48 loops 60. The preferred materials of construction for the band element 48 is a twenty five (25) millimeter wide webbing from Cansew, Inc. part number 7166 or any other like material that is lightweight, waterproof, and has adequate strength to retain the vessel 66. The preferred materials of construction for the collar 46 can match those of either the resilient sleeve 32 as previously described or the band element 48 also as previously described. For the resilient sleeve 32 being adjacent to the band element 48 first end portion 52 and the band element 48 second end portion 54, and optionally for the collar 46 being adjacent to the band element loop 60, the preferred attachment is by conventional sewing, however, other attachment methods may be employed such as hook and loop fasteners, snaps, rivets, pins, clips, and the like that meet the previously discussed requirements for the materials of construction of the resilient sleeve 32, band element 48, and collar 46.

As a further option the vessel retainer apparatus 30 can further comprise a human waistline connector 62 that is operational to removably engage the vessel retainer apparatus 30 from the human user 92 as best shown in use in FIGS. 6 and 7 and in structural detail in FIGS. 1, 2, 4, and 5. The human waistline connector 62 is preferably a clip or snap loop type as is shown in FIGS. 1, 2, 4, and 5, for use with the waist or belt loop of pants or a skirt, however, alternative types of the human waistline connector 62 such as loop types for use with a belt, or any other removable engagement to the human waistline would be acceptable that was waterproof and had enough strength to stay adjacent 98 to the human 92 during sports activities thus keeping the vessel retainer apparatus 30 adjacent to the human user 92. In addition as an optional alternative, the vessel retainer apparatus 30 can further comprise a human shoulder strap connector 64 that is operational to removably engage the vessel retainer apparatus 30 from the human user 92 as best shown in FIG. 8, with the shoulder strap connector 64 being preferably constructed of a twenty five (25) millimeter wide webbing from Cansew, Inc. part number 7166 or any other like material that is lightweight, waterproof, and has adequate strength to retain the vessel retainer apparatus 30 adjacent to the human user 92.

Broadly, in referring specifically to FIG. 3 for physical structure and FIGS. 4 through 8 for method of use, the alternative embodiment of the vessel retainer apparatus 31 for removably engaging a vessel 66 is shown, with the vessel retainer apparatus 31 being adapted 100 to be carried adjacent 98 to a human user 92. The vessel retainer apparatus 31 assembly includes a resilient sleeve 44 having a circumferential axis 47 and an axial axis 49, with the resilient sleeve 44 being sized and configured to have a portion of the resilient sleeve 44 partially radially encapsulate 51 a section 74 of a frustroconical portion 72 of the vessel 66 that is adjacent to a vessel neck portion 76 as best shown in FIG. 4. Also included in the vessel retainer apparatus 31 is stiffening member 42 disposed circumferentially adjacent to the resilient sleeve 44, wherein the stiffening member 42 is operational to help a portion of the resilient sleeve 44 along the axial axis 49 substantially retain a circular shape along the circumferential axis 47.

Further included in the vessel retainer apparatus 31 is a band element 48 having a longitudinal axis 50 spanning from a band element first end portion 52 to a band element second end portion 54, wherein the band element 48 is adjacent 57 to the sleeve 44 at the first end portion 52 and the second end portion 54. The band element 48 is positioned such that the longitudinal axis 50 and the circumferential axis 47 are substantially transverse 59 to one another with the band 48 substantially forming a loop 60 between the first end portion 52 and the second end portion 54. Wherein operationally the vessel 66 is removably engaged 78 to the vessel retainer apparatus 31 by the vessel 66 being partially disposed 88 within the loop 60 and the resilient sleeve 44 partially radially encapsulating 51 the frustroconical portion 72 of the vessel 66. In addition to the band element 48 loop 60 receiving the vessel 66 body portion 68 and the vessel 66 base portion 70 as best shown in FIGS. 4 and 5, with the stiffening member 42 assisting in an easy entry of a vessel 66 base portion 70 there through the resilient sleeve 44 along the axial axis 49 in opening 45 as best shown by the combination of FIGS. 3, 4, and 7.

The preferred materials of construction for the resilient sleeve 44 is a twenty five (25) millimeter wide elastic strap from Cansew, Inc. part number CSK 3500, a close cell foam rubber, or any other alternative material that is lightweight, waterproof, and having adequate strength at the resilient sleeve 44 partial radial encapsulation 51 of the vessel 66 frustroconical portion 72 to create adequate retaining force 82 from the resilient sleeve 44 to the frustroconical portion 72 to enable vessel 66 removable engagement 78 relative to the vessel retainer apparatus 31 as shown in FIGS. 3, 4, and 5 even with the stiffening member 44 in place as shown in FIG. 3. As to the stiffening member 42 the preferred materials of construction are a reasonably rigid plastic or any other material that can substantially retain the sleeve 44 along the circumferential axis 47 and forming opening 45 about axis 49, however, allowing the sleeve 44 to have the partial radial encapsulation 51 of the vessel 66 frustroconical portion 72 to create adequate retaining force 82 from the resilient sleeve 44 to the frustroconical portion 72 to enable vessel 66 removable engagement 78 relative to the vessel retainer apparatus 31 as shown in FIGS. 3, 4, and 5.

As an option the vessel retainer apparatus 31 can further comprise a plurality of band elements 48 that are positioned in a substantially juxtapose manner to one another as best shown in FIG. 3. Further, as another option the vessel retainer apparatus 31 can further comprise a collar 46 that is adjacent to the plurality band element loops 60 with the collar 46 being positioned substantially juxtapose to the resilient sleeve 44 as shown in FIG. 3 for the sleeve 44 and wherein the collar 46 juxtapose positioning is shown with sleeve 32 in FIG. 5, thus the juxtapose positioning is substantially the same for collar 46 in relation to sleeve 44 (not shown) as for sleeve 32 (shown in FIG. 5). In addition, a yet further option for the vessel retainer apparatus 31 can further comprise the collar 46 that is adjacent to a single band element loop 60 and positioned substantially juxtapose to the resilient sleeve 44 or as previously discussed in substantially the same positional relation as sleeve 32, although not shown in FIG. 5, specifically with the collar 46 in conjunction with a single band element loop 60, thus would not affect the positioning of the collar 46 as shown in FIG. 5 only having a single band element loop 60. Also, there could be a plurality of collars 46 that could be adjacent to a single band element loop 60, wherein the collars 46 are all substantially juxtapose to the resilient sleeve 44, further there could be a plurality of collars 46 that could be adjacent to a plurality of band element loops 60, wherein the collars are all substantially juxtapose to the resilient sleeve 44 and the band element loops 60 are all substantially juxtapose to one another.

Operationally, the collar 46 further helps the band element 48 loops 60 remain substantially juxtapose to one another, either with a single band element 48 loop 60 or a plurality of band element 48 loops 60. The preferred materials of construction for the band element 48 is a twenty five (25) millimeter wide webbing from Cansew, Inc. part number 7166 or any other like material that is lightweight, waterproof, and has adequate strength to retain the vessel 66. The preferred materials of construction for the collar 46 can match those of either the resilient sleeve 44 as previously described or the band element 48 also as previously described. For the resilient sleeve 44 being adjacent to the band element 48 first end portion 52 and the band element 48 second end portion 54 and optionally for the collar 46 being adjacent to the band element loop 60, the preferred attachment is by conventional sewing, however, other attachment methods may be employed such as hook and loop fasteners, snaps, rivets, pins, clips, and the like that meet the previously discussed requirements for the materials of construction of the resilient sleeve 44, band element 48, and collar 46.

As a further option the vessel retainer apparatus 31 can further comprise a human waistline connector 62 that is operational to removably engage the vessel retainer apparatus 31 from the human user 92 as best shown in use in FIGS. 6 and 7 and in physical structural detail in FIG. 2 (only looking at the human waistline connector 62) and FIG. 3. The human waistline connector 62 is preferably a clip or snap loop type as is shown in FIGS. 2 and 3, for use with the waist or belt loop of pants or a skirt, however, alternative types of the human waistline connector 62 such as loop types for use with a belt, or any other removable engagement to the human waistline would be acceptable that was waterproof and had enough strength to stay adjacent to the human 92 during sports activities thus keeping the vessel retainer apparatus 31 adjacent 98 to the human user 92. In addition as an optional alternative, the vessel retainer apparatus 31 can further comprise a human shoulder strap connector 64 that is operational to rmovably engage the vessel retainer apparatus 31 from the human user 92 as best shown in FIG. 8, with the shoulder strap connector 64 being preferably constructed of a twenty five (25) millimeter wide webbing from Cansew, Inc. part number 7166 or any other like material that is lightweight, waterproof, and has adequate strength to retain the vessel retainer apparatus 30 adjacent to the human user 92.

### Method of Use

In referring in particular to FIG. 3 for physical detail on the vessel retainer apparatus 31 alone, FIGS. 4 and 5 for detail on the vessel retainer apparatus 31 and vessel 66 interface, and FIGS. 6 through 8 for the use of the vessel retainer apparatus 31, a method is disclosed for the use of a vessel retainer apparatus 31, that comprises the steps of firstly providing a vessel retainer apparatus 31. The vessel retainer apparatus 31 includes a resilient sleeve 44 having a circumferential axis 47 and an axial axis 49, the resilient sleeve 44 is sized and configured to have a portion of the resilient sleeve 44 partially radially encapsulate 51 a section 74 of a frustroconical portion 72 of the vessel 66 that is adjacent to a vessel neck portion 76. The vessel retainer apparatus 31 also includes a stiffening member 42 disposed circumferentially adjacent to the resilient sleeve 44, a band element 48 having a longitudinal axis 50 spanning from a first end portion 52 to a second end portion 54, wherein the band element 48 is adjacent 57 to the sleeve 44 at the first end portion 52 and the second end portion 54. The band element 48 is positioned such that the longitudinal axis 50 and the circumferential axis 47 are substantially transverse 59 to one another with the band 48 substantially forming a loop 60. Further included, in the vessel retainer apparatus 31 is a human waistline connector 62, wherein the stiffening member 42 is operational to help a portion of the resilient sleeve 44 along the axial axis 49 substantially retain a circular opening 45 along the circumferential axis is 47 forming the opening 45 as best shown in FIG. 3.

Further, a second step is in attaching the vessel retainer apparatus 31 to a waistline area of a human user 92 using the human waistline connector 62 as best shown in FIGS. 6 and 7 for the attached vessel retainer apparatus 31 to the human user 92 waistline, with the waistline connector 62 structural detail as best shown in FIGS. 2 and 3. Next, a third step is in manually grasping a neck portion 76 of the vessel 66 with a single hand 94 of the human user 92 as shown in FIG. 7 and continuing in a forth step, again see FIG. 7, of inserting 84 a base portion 70 of the vessel 66 into the opening 45 of the resilient sleeve 44 with the single hand 94 of the human user 92 and without the aid of human eye contact 96 and continuing an inserting 84 movement until the base portion 70 of the vessel 66 contacts the band 48 loop 60 and bottoms out the vessel 66 in the vessel retainer apparatus 31, looking at FIG. 4 for the bottoming of the vessel base portion 70 in the band loop 60. Wherein in the resilient sleeve 44 partially radially encapsulates 51 a section 74 of the frustroconical portion 72 of the vessel 66 that is adjacent to the vessel neck portion 76, operationally helping to retain in a removably engaged manner 86 the vessel 66 in the vessel retainer apparatus 31, in referring to FIGS. 3 and 4, in other words using the vessel retainer apparatus 31 without the vessel 66 as shown in FIG. 3 to retain the vessel 66 as shown in FIG. 4. With the stiffening member 42 assisting in an easy entry 90 of the vessel base portion 70 therethrough the resilient sleeve 44 opening 45 along the axial axis 49.

An optional further step, in looking at FIG. 7, in for the method of using the vessel retainer apparatus 31 in extracting 80 the vessel 66 from the vessel retainer apparatus 31 by grasping the neck portion 76 with the single hand 94 by feel without any eye contact 96 and pulling 80 the neck portion 76 opposite of the band loop 60 to overcome a retaining force 82 (see FIG. 4) of the resilient sleeve 44 (from FIG. 3) partially radially encapsulates 51 a section 74 of a frustroconical portion 72 of the vessel 66, thus completely removing the vessel 66 from the vessel retainer apparatus 31.

### Conclusion

Accordingly, the present invention of the vessel retainer apparatus 30 or 31 assembly has been described with some degree of particularity directed to the embodiments of the present invention. It should be appreciated, thought; that the present invention is defined by the following claims constructed in light of the prior art so modifications of the changes may be made to the exemplary embodiments of the present invention without departing from the inventive concepts contained the rein.

1. A vessel retainer apparatus for removably engaging a vessel, said apparatus adapted to be carried adjacent to a human user, comprising:
(a) a resilient sleeve having a circumferential axis, said resilient sleeve is sized and configured to have a portion of said resilient sleeve partially radially encapsulate a section of a frustroconical portion of the vessel that is adjacent to a vessel neck portion; and
(b) a band element having a longitudinal axis spanning from a first end portion to a second end portion, wherein said band element is adjacent to said sleeve at said first end portion and said second end portion, said band element is positioned such that said longitudinal axis and said circumferential axis are substantially transverse to one another with said band substantially forming a loop between said first end portion and said second end portion, wherein operationally the vessel is removably engaged to said vessel retainer apparatus by the vessel being partially disposed within said loop and said resilient sleeve partially radially encapsulating the frustroconical portion of the vessel.

2. A vessel retainer apparatus according to claim 1 further comprising a plurality of said band elements that are positioned in a substantially juxtapose manner to one another.

3. A vessel retainer apparatus according to claim 2 further comprising a collar that is adjacent to said plurality of band element loops and said collar is positioned substantially juxtapose to said resilient sleeve.

4. A vessel retainer apparatus according to claim 1 further comprising a collar that is adjacent to said band element loop and positioned substantially juxtapose to said resilient sleeve.

5. A vessel retainer apparatus according to claim 1 further comprising a human waistline connector that is operational to removably engage said vessel retainer apparatus from the human user.

6. A vessel retainer apparatus according to claim 1 further comprising a human shoulder strap connector that is operational to removably engage said vessel retainer apparatus from the human user.

7. A vessel retainer apparatus according to claim 1 wherein said resilient sleeve is constructed of a close cell foam rubber.

8. A vessel retainer apparatus for removably engaging a vessel, said apparatus adapted to be carried adjacent to a human user, comprising:
(a) a resilient sleeve having a circumferential axis and an axial axis, said resilient sleeve is sized and configured to have a portion of said resilient sleeve partially radially encapsulate a section of a frustroconical portion of the vessel that is adjacent to a vessel neck;
(b) a stiffening member disposed circumferentially adjacent to said resilient sleeve, wherein said stiffening member is operational to help a portion of said resilient sleeve along said axial axis substantially retain a circular shaped opening along said circumferential axis and about said axial axis; and
(c) a band element having a longitudinal axis spanning from a first end portion to a second end portion, wherein said band element is adjacent to said sleeve at said first and portion and said second end portion, said band element is positioned such that said longitudinal axis and said circumferential axis are substantially transverse to one another with said band substantially forming a loop between said first end portion and said second end portion, wherein operationally the vessel is removably engaged to said vessel retainer apparatus by the vessel being partially disposed within said loop and said resilient sleeve partially radially encapsulating the frustroconical portion of the vessel, with said stiffening member assisting in an easy entry of a vessel base portion therethrough said resilient sleeve opening about said axial axis.

9. A vessel retainer apparatus according to claim 8 further comprising a plurality of said band elements that are positioned in a substantially juxtapose manner to one another.

10. A vessel retainer apparatus according to claim 9 further comprising a collar that is adjacent to said plurality of band element loops and said collar is positioned substantially juxtapose to said resilient sleeve.

11. A vessel retainer apparatus according to claim 8 comprising a collar that is adjacent to said band element loop and positioned substantially juxtapose to said resilient sleeve.

12. A vessel retainer apparatus according to claim 8 further comprising a human waistline connector that is operational to removably engage said vessel retainer apparatus form the human user.

13. A vessel retainer apparatus according to claim 8 further comprising a human shoulder strap connector that is operational to removably engage said vessel retainer apparatus from the human user.

14. A vessel retainer apparatus according to claim 8 wherein said resilient sleeve is constructed of a close cell foam rubber.

15. A vessel retainer apparatus according to claim 8 wherein said stiffening member is constructed of plastic.

16. A method of using a vessel retainer apparatus, comprising the steps of:
(a) providing a vessel retainer apparatus that includes a resilient sleeve having a circumferential axis and an axial axis, said resilient sleeve is sized and configured to have a portion of said resilient sleeve partially radially encapsulate a section of a frustroconical portion of the vessel that is adjacent to a vessel neck portion, a stiffening member disposed circumferentially adjacent to said resilient sleeve, a band element having a longitudinal axis spanning from a first end portion to a second end portion, wherein said band element is adjacent to said sleeve at said first end portion and said second end portion, said band element is positioned such that said longitudinal axis and said circumferential axis are substantially transverse to one another with said band substantially forming a loop between said first end portion and said second end portion, and a human waistline connector, wherein said stiffening member is operational to help a portion of said resilient sleeve along said axial axis substantially retain a circular shaped opening along said circumferential axis and about said axial axis;
(b) attaching said vessel retainer apparatus to a waistline area of a human user using said human waistline connector.
(c) grasping a neck portion of a vessel with a single hand of the human user; and
(d) inserting a base portion of the vessel into said opening of said resilient sleeve with the single hand of the human user and without the aid of human eye contact and continuing an inserting movement until the base portion of the vessel contacts said band loop and bottoms out the vessel in said vessel retainer apparatus, wherein said resilient sleeve partially radially encapsulates a section of a frustroconical portion of the vessel that is adjacent to a vessel neck portion, operationally helping to retain the vessel in the vessel retainer apparatus, with said stiffening member assisting in an easy entry of the vessel base portion therethrough said resilient sleeve opening along said axial axis.

17. A method of using a vessel retainer apparatus according to claim 16 further comprising a step of extracting the vessel from said vessel retainer apparatus by grasping the neck portion with the single hand by feel without any eye contact and pulling the neck portion opposite of said band loop to overcome a retaining force of said resilient sleeve partially radially encapsulates a section of a frustroconical portion of the vessel, thus completely removing the vessel from said vessel retainer apparatus.
